(19) United States
(12) Patent Application Publication
(10) Pub. No.: US 2024/0240010 A1
(43) Pub. Date: Jul. 18, 2024

(54) THERMOPLASTIC COMPOSITION AND METHOD FOR PRODUCING THE SAME, AND MOLDING PRODUCT

(71) Applicant: Chimei Corporation, Tainan City (TW)

(72) Inventor: Keng-Chu Lin, Tainan City (TW)

(21) Appl. No.: 18/413,413

(22) Filed: Jan. 16, 2024

(30) Foreign Application Priority Data
Jan. 17, 2023 (TW) 112102041
Nov. 1, 2023 (TW) 112142006

(51) Int. Cl. C08L 51/00

(52) U.S. Cl. CPC C08L 51/003; C08L 2205/03

(57) ABSTRACT

The present invention provides a thermoplastic composition and a method for producing the same, and a molding product. The thermoplastic composition comprises 100 parts by weight of acrylate-based rubber modified resin composition (A), 0.05 parts by weight to 10 parts by weight of paraffin wax (B), and 0.1 parts by weight to 2 parts by weight of hindered amine light stabilizing composition with a dipiperidine structure (C1). The acrylate-based rubber modified resin composition (A) includes styrene-acrylonitrile copolymers and acrylate-based rubber grafted copolymers.

### RELATED APPLICATION

This application claims priority to Taiwan Application Serial Number 112102041, filed Jan. 17, 2023, and Taiwan Application Serial Number 112142006, filed Nov. 1, 2023, the disclosures of which are incorporated herein by reference in their entireties.

### BACKGROUND

### Field of Invention

The present invention relates to a thermoplastic composition. More particularly, the present invention relates to the thermoplastic composition to reduce odor of thermoplastic resin and improve chemical resistance, mobility and low gloss, as well as its resulting molding product.

### Description of Related Art

Acrylonitrile Styrene Acrylate (ASA) resin is a kind of thermoplastic styrene resin, which is produced by copolymerization of polyacrylate rubber, styrene monomer and acrylonitrile. It is employed in various fields, such as automobile interior parts, building materials and etc., and is widely used in recent years.

When employing ASA resin to fabricate the building materials, such as window frames, these frames serve a dual purpose for both interior and exterior applications. It is important for the frames to have low odor efficacy to ensure safety during long-term indoor contact with human beings. This helps to avoid any potential harm to the human body; further, the frames need to possess chemical resistance to resist corrosion from chemicals in the outdoor environment. Moreover, since the window frame parts have larger volume, it shows extremely high demands on excellent processability and resin mobility. Additionally, it is necessary for the window frames to have low gloss efficacy to avoid impairing vision caused by specular reflection. Therefore, in order to fulfill needs of low odor for building materials and automobile interior parts, the ASA resin, which also offers chemical resistance, mobility and low gloss, has market demand for its molding product.

However, if known ASA resin is desired to reduce odor, decrease gloss or increase mobility, it is needed to add various functional additives such as an odor suppressant, a matting agent or a lubricant. However, this approach is often less effective and cannot fulfill low odor, great chemical resistance, high mobility and low gloss simultaneously.

Therefore, it is necessary to provide a thermoplastic composition and a method for producing the same, and a molding product to address the shortcomings of the known ASA resin materials.

### SUMMARY

As above, an aspect of the present invention provides the thermoplastic composition and the method for producing the same, and the molding product formed from the thermoplastic composition, which has properties of low odor, great chemical resistance, high mobility and low gloss.

The thermoplastic composition of the present invention includes 100 parts by weight of acrylate-based rubber modified resin composition (A), 0.05 part by weight to 10 parts by weight of paraffin wax (B), and 0.1 part by weight to 2 parts by weight of hindered amine light stabilizing composition with a dipiperidine structure (C1), in which the acrylate-based rubber modified resin composition (A) includes styrene-acrylonitrile copolymers and acrylate-based rubber grafted copolymers, and a molecular weight of the hindered amine light stabilizing composition with a dipiperidine structure (C1) is ranging from 200 g/mole to 600 g/mole.

According to some embodiments of the present invention, the paraffin wax (B) comprises saturated hydrocarbon with a carbon number of 17 to 50.

According to some embodiments of the present invention, a melting point of the paraffin wax (B) is below 75° C.

According to some embodiments of the present invention, a melting point of the paraffin wax (B) is above 40° C., but below 75° C.

According to some embodiments of the present invention, a weight ratio between the paraffin wax (B) and the hindered amine light stabilizing composition with a dipiperidine structure (C1) is 0.025 to 100.

According to some embodiments of the present invention, the hindered amine light stabilizing composition with a dipiperidine structure (C1) has a structure of following formula (I).

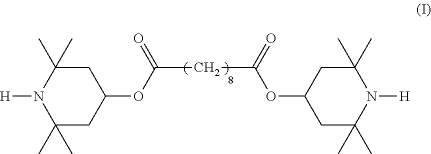

According to some embodiments of the present invention, the thermoplastic composition can optionally include 0.1 part by weight to 1.6 parts by weight of hindered amine light stabilizing composition (C2), and a molecular weight of the hindered amine light stabilizing composition (C2) is ranging from 1000 g/mole to 5000 g/mole.

According to some embodiments of the present invention, the hindered amine light stabilizing composition (C2) comprises a structure (structures) of following formula (II) and/or formula (III). In the formula (II), n represents an integer between 2 and 20.

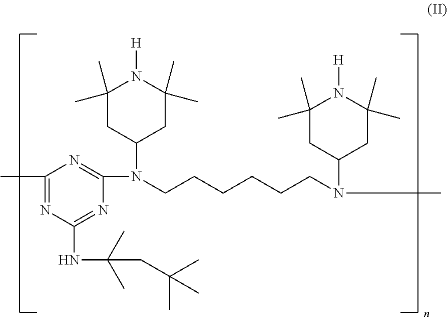

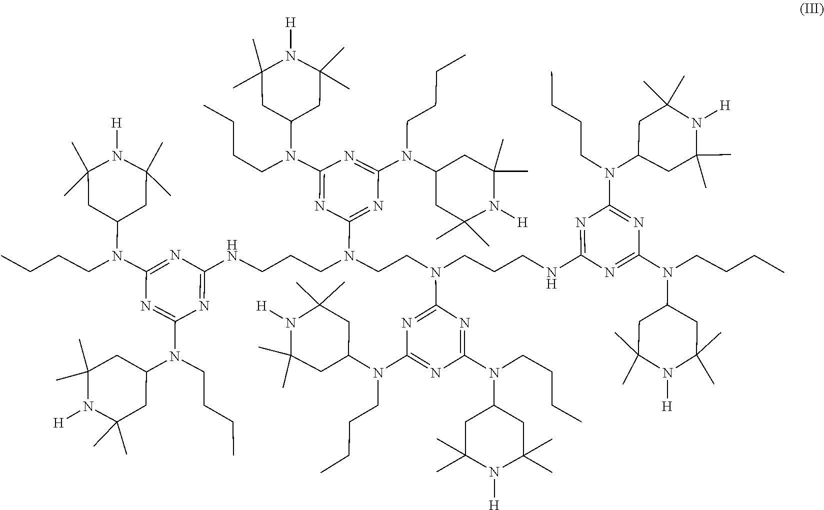 [SMILES: CCCCN(c1nc(NCCCN(CCN(CCCNc2nc(N(CCCC)C3CC(C)(C)NC(C)(C)C3)nc(N(CCCC)C3CC(C)(C)NC(C)(C)C3)n2)c2nc(N(CCCC)C3CC(C)(C)NC(C)(C)C3)nc(N(CCCC)C3CC(C)(C)NC(C)(C)C3)n2)c2nc(N(CCCC)C3CC(C)(C)NC(C)(C)C3)nc(N(CCCC)C3CC(C)(C)NC(C)(C)C3)n2)nc(N(CCCC)C2CC(C)(C)NC(C)(C)C2)n1)C1CC(C)(C)NC(C)(C)C1]

According to some embodiments of the present invention, an amount of the hindered amine light stabilizing composition (C2) with the structure of the formula (III) is 0.1 part by weight to 1.0 part by weight.

According to some embodiments of the present invention, a weight ratio between the hindered amine light stabilizing composition with a dipiperidine structure (C1) and the hindered amine light stabilizing composition (C2) is 0.06 to 20.

According to some embodiments of the present invention, the thermoplastic composition can optionally include 0.1 part by weight to 1.5 parts by weight of an ultraviolet light stabilizing composition (D).

According to some embodiments of the present invention, the ultraviolet light stabilizing composition (D) is selected from the group consisting of benzotriazole-based ultraviolet light stabilizing composition.

According to some embodiments of the present invention, the ultraviolet light stabilizing composition (D) is selected from the group consisting of 2-(2′-hydroxy-5′-tert-octylphenyl)benzotriazole or 2,2′-methylenebis[6-(benzotriazol-2-yl)-4-tert-octylphenol].

According to some embodiments of the present invention, a weight ratio between the hindered amine light stabilizing composition with a dipiperidine structure (C1) and the ultraviolet light stabilizing composition (D) is 0.06 to 20.

According to some embodiments of the present invention, the thermoplastic composition can optionally include 0.1 part by weight to 10 parts by weight of a coloring agent, a dye and/or a pigment (E).

According to some embodiments of the present invention, the thermoplastic composition can optionally include 0.05 part by weight to 5 parts by weight of other additives (F).

Another aspect of the present invention provides the molding product, which includes the aforementioned thermoplastic composition.

Yet another aspect of the present invention provides the method for producing the thermoplastic composition. The method includes providing a composition, in which the composition includes 100 parts by weight of acrylate-based rubber modified resin composition (A), 0.05 part by weight to 10 parts by weight of paraffin wax (B), and 0.1 part by weight to 2 parts by weight of hindered amine light stabilizing composition with a dipiperidine structure (C1). The acrylate-based rubber modified resin composition (A) comprises styrene-acrylonitrile copolymers and acrylate-based rubber grafted copolymers, and a molecular weight of the hindered amine light stabilizing composition with a dipiperidine structure (C1) is ranging from 200 g/mole to 600 g/mole. The method further includes performing a compounding operation to the composition to obtain the thermoplastic composition.

According to some embodiments of the present invention, the paraffin wax (B) comprises saturated hydrocarbon with a carbon number of 17 to 50.

According to above, the present invention provides the thermoplastic composition and the method for producing the same, and the molding product. The thermoplastic composition includes 100 parts by weight of acrylate-based rubber modified resin composition (A), 0.05 part by weight to 10 parts by weight of paraffin wax (B), and 0.1 part by weight to 2 parts by weight of hindered amine light stabilizing composition with a dipiperidine structure (C1), in which the acrylate-based rubber modified resin composition (A) comprises styrene-acrylonitrile copolymers and acrylate-based rubber grafted copolymers, and a molecular weight of the hindered amine light stabilizing composition with a dipiperidine structure (C1) is ranging from 200 g/mole to 600 g/mole. By composition with the aforementioned amounts, the thermoplastic composition of the present invention can have properties of low odor, great chemical resistance, high mobility and low gloss.

These and other features, aspects, and advantages of the present invention will become better understood with reference to the following description and appended claims.

### DETAILED DESCRIPTION

Production and utilization of embodiments of the present invention will be made in detail in the following. However, it is understood that the embodiments provides may applicable inventive concept, which can be implemented in various contents. The discussed embodiments are only for illustrative purpose, but not be interpreted in anyway as to limit the scope of the present invention.

In order to produce a resin composition with properties of low odor, great chemical resistance, high mobility and low gloss, the present invention provides the thermoplastic composition, which can achieve the above advantages. The embodiments are cited as an example of the manner in which the present invention can be implemented.

The thermoplastic composition provided by some embodiments of the present invention provides includes 100 parts by weight of acrylate-based rubber modified resin composition (A), 0.05 part by weight to 10 parts by weight of paraffin wax (B), and 0.1 part by weight to 2 parts by weight of hindered amine light stabilizing composition with a dipiperidine structure (C1). In some embodiments, the thermoplastic composition of the present invention can optionally include 0.1 part by weight to 1.6 parts by weight of hindered amine light stabilizing composition (C2); 0.1 part by weight to 1.5 parts by weight of an ultraviolet light stabilizing composition (D); a coloring agent, a dye and/or a pigment (E); other additives (F); or combinations thereof. The following describes the above components in detail.

### Acrylate-Based Rubber Modified Resin Composition (A)

The acrylate-based rubber modified resin composition (A) of the present invention includes continuous phase formed by styrene-acrylonitrile copolymers and disperse phase formed by acrylate-based rubber grafted copolymers. In detail, the acrylate-based rubber modified resin composition (A) includes 55 weight percent (wt %) to 80 wt % of the styrene-acrylonitrile copolymers, and 20 wt % to 45 wt % of the acrylate-based rubber grafted copolymers. From another point of view, the acrylate-based rubber modified resin composition (A) includes 15 wt % to 25 wt % of acrylonitrile monomeric units, 55 wt % to 65 wt % of styrene monomeric units and 15 wt % to 25 wt % of acrylate monomeric units.

The styrene-acrylonitrile copolymers can be produced by polymerization reaction from 60 wt % to 74 wt % of styrene monomeric units and 26 wt % to 40 wt % of acrylonitrile monomeric units. The polymerization reaction can be performed by bulk polymerization, solution polymerization, suspension polymerization, emulsion polymerization or other suitable methods, in which the bulk polymerization or solution polymerization are preferable. Examples of the styrene monomers include but are not limited to styrene, α-methyl styrene, 4-tert-butyl styrene, 4-methyl styrene, 2-methyl styrene, 3-methyl styrene, 2, 4-dimethyl styrene, ethyl styrene, p-methyl-α-methyl styrene, bromostyrene, and etc., in which styrene or α-methyl styrene are preferable. Examples of the acrylonitrile monomers include but are not limited to acrylonitrile or 2-methylacrylonitrile, in which acrylonitrile is preferable.

The aforementioned acrylate monomeric units, styrene monomeric units and acrylonitrile monomeric units represent repeating units in the acrylate-based rubber grafted copolymers or the styrene-acrylonitrile copolymers after the polymerization and grafting reaction of acrylate monomers, styrene monomers and acrylonitrile monomers, respectively.

In addition, a producing method for the styrene-acrylonitrile copolymers prefers to include using a reactor capable of performing continuous bulk polymerization or solution polymerization to perform the polymerization reaction. The reactor can include but not be limited to a plug flow reactor, a continuous stirred tank reactor (CSTR), or a tubular reactor including static mixing elements, and etc., in which the continuous stirred tank reactor is preferable. The reactor can be used in quantity of one, or combination of two or more.

In some embodiments, the producing method for the styrene-acrylonitrile copolymers is performed by the solution polymerization. Solvents used in the solution polymerization can be, for example, toluene, ethylbenzene or methyl ethyl ketone, and etc. Preferably, an operation temperature of the solution polymerization is 70° C. to 140° C.; more preferably, the operation temperature of the solution polymerization is 90° C. to 130° C.

In some embodiments, when producing the styrene-acrylonitrile copolymers, a thermal polymerization method can be used or a polymerization initiator is added into the reaction, in which the polymerization initiator can include but not be limited to hydroperoxide compounds, such as tert-butyl hydroperoxide, or isopropylcumyl hydroperoxide, and etc.; peroxyketal compounds, such as 1,1-Di-(tert-butylperoxy)-3,3,5-trimethylcyclohexane, or 2,2-di-(4,4-di(tert-butylperoxy)cyclohexyl)propane, and etc.; diacyl peroxide compounds, such as dilauroyl peroxide, didecanoyl peroxide, or dibenzoyl peroxide (BPO); peroxyester compounds, such as t-butylperoxy pivalate, or 2,5-dimethyl-2,5-di(2-ethylhexanoyl peroxy)hexane, and etc.; ketone peroxide compounds, such as 4,4-di-t-butyl peroxy valeric acid-n-butyl ester (also called TX-17); peroxycarbonate compounds, such as tert-amylperoxy 2-ethylhexyl carbonate, or tert-butylperoxy 2-ethylhexyl carbonate; and diazo compounds with nitro group and cyclohexyl group. Based on total amount of the styrene monomers and the acrylonitrile monomers as 100 parts by weight, an amount of the polymerization initiator can be 0.01 part by weight to 2.0 parts by weight, and 0.01 part by weight to 1.0 part by weight is preferable.

In some embodiments, a molecular weight of the obtained styrene-acrylonitrile copolymers is 60000 to 40000.

The acrylate-based rubber grafted copolymers is produced from grafting polymerization reaction of 100 parts by weight of acrylate-based rubber emulsion and 50 parts by weight to 100 parts by weight of monomer mixture, in which the monomer mixture includes 65 wt % to 75 wt % of styrene monomers and 25 wt % to 35 wt % of acrylonitrile monomers. Adding method of the monomer mixture can be added at once, added in batches, added continuously, or various monomers of the monomer mixture can be added in stages. In addition, the acrylate-based rubber grafted copolymers can include two or more kinds of the acrylate-based rubber grafted copolymers with different weight average particle sizes, respectively. In some embodiments, the weight average particle sizes of the acrylate-based rubber grafted copolymers show a bimodal distribution with peaks at 0.12 μm and 0.45 μm.

A producing method for the acrylate-based rubber emulsion includes performing the polymerization reaction by the emulsion polymerization directly on the acrylic monomers as main components. The acrylic monomers can be, for example, methyl methacrylate, ethyl methacrylate, propyl methacrylate, butyl methacrylate, n-amyl methacrylate, hexyl methacrylate, heptyl methacrylate, 2-ethylhexyl methacrylate, methyl acrylate, ethyl acrylate, propyl acrylate, n-butyl acrylate, n-pentyl acrylate, hexyl acrylate, heptyl acrylate, 2-ethylhexyl acrylate, dodecyl acrylate, or other suitable acrylic monomers, in which n-butyl acrylate is preferable. The acrylic monomers can be used individually or used in combinations of several ones.

In addition, the producing method for the acrylate-based rubber emulsion can optionally include adding a crosslinking agent when performing the polymerization reaction. The crosslinking agent can include but not be limited to ethylene diacrylate, 1,4-butanediol diacrylate, divinylbenzene, 1,4-butanediol dimethacrylate, dimethacrylate, trimethylolpropane trimethacrylate, allyl methacrylate (AMA), diallyl methacrylate, diallyl maleate, diallyl fumarate, diallyl phthalate, triallyl methacrylate, triallyl cyanurate, triallyl isocyanurate, tricyclodecenyl acrylate, polyakylene glycol diacrylate, or other suitable crosslinking agents. The crosslinking agent can be used individually or used in combinations of several ones. In some embodiments, based on total amount of the acrylic monomers and the crosslinking agent as 100 wt %, a preferable amount of the crosslinking agent is 0.1 wt % to 10 wt %.

In some embodiments, the average particle size of the acrylate-based rubber emulsion can be controlled by a copolymerization condition. For example, reaction conditions such as a polymerization temperature, amounts or types of initiators, emulsifiers, activators, and adding method of the monomers can be modified to control the average particle size of the acrylate-based rubber emulsion.

The initiators can be any conventional free radical polymerization initiators, and adding method of the initiators can be added at once, added continuously, or added incrementally. In detail, examples of the initiators can include but are not limited to benzoyl peroxide, layroyl peroxide, oleyl peroxide, toluyl peroxide, dicumyl peroxide, tert-butyl peroxide, di-tert-butyl diperphthalate, tert-butyl peracetate, tert-butyl perbenzoate, isoperopyl peroxy dicarbonate, 2,5-dimethyl-2,5-di(tert-butyl peroxy)hexane, tert-butyl hydroperoxide, 2,5-dimethyl-2,5-di(tert-butylperoxy) hexane-3-tert-butyl hydroperoxide, cumene hydroperoxide, p-methane hydroperoxide, cyclopentane hydroperoxide, diisopropylbenzene hydroperoxide, p-tert-butylcumene hydroperoxide, pinane hydroperoxide, 2,5-dimethyl-hexane-2,5-dihydroperoxide or mixtures of the aforementioned initiators.

In some embodiments, based on total amounts of monomer mixtures as 100 parts by weight, an amount of the initiators can be 0.01 part by weight to 5 parts by weight.

Examples of the emulsifiers can include but are not limited to carboxylates such as sodium succinate, potassium aliphatate, sodium aliphatate, dipotassium alkenyl succinate, soap of rosolic acid; sulfonate compounds such as sodium dihexyl sulfosuccinate, alkylsulfates or sodium alkyl benzene sulfonates; anionic emulsifiers such as sodium nonylphenol polyoxyethylene ether sulfate. In some embodiments, based on total amounts of monomer mixtures as 100 parts by weight, an amount of the emulsifiers can be 1 part by weight to 10 parts by weight.

Examples of the activators can include but are not limited to ferrous sulfate, Sodium formaldehydesulfoxylate, ethylenediaminetetraacetic acid disodium salt, tetrasodium pyrophosphate, and etc. In some embodiments, based on total amounts of monomer mixtures as 100 parts by weight, an amount of the activators can be 1 part by weight to 10 parts by weight.

In some embodiments, graft molecular weight of the acrylate-based rubber grafted copolymers can also modified by changing polymerization conditions such as the polymerization temperature, amounts or types of the initiators, the emulsifiers, the activators or chain transfer agents, and the adding method of the monomers. The reaction temperature of the grafting polymerization is not greater than 90° C., and 25° C. to 40° C. is preferable. Types and amounts of the initiators, the emulsifiers and the activators are described above. Examples of the chain transfer agents can include n-butyl mercaptan, n-octyl mercaptan, n-dodecyl mercaptan or tert-dodecyl mercaptan, and etc. In an embodiment, based on total amounts of monomer mixtures as 100 parts by weight, an amount of the chain transfer agents can be 0.01 part by weight to 0.1 part by weight.

It should be noted that when the grafting reaction is performed to from the acrylate-based rubber grafted copolymers, the polymerization reaction can be performed on the styrene and the acrylonitrile to produce second styrene-acrylonitrile copolymers. In an embodiment, a molecular weight of the second styrene-acrylonitrile copolymers is ranging from 10000 to 100000.

In addition, examples of the styrene monomer and the acrylonitrile monomer included in the monomer mixtures are the same as examples of the styrene monomer and the acrylonitrile monomer used to produce the styrene-acrylonitrile copolymers, and thus it is not repeated herein.

The producing method for the acrylate-based rubber modified resin composition (A) is not limited specifically, and thus, a normal mixing method can be used, for example, the styrene-acrylonitrile copolymers and the acrylate-based rubber grafted copolymers are mixed homogeneously. In some embodiments, the normal mixing method can include melt mixing by a mixer such as an extrusion mixer, a kneader reactor or a Banbury mixer after dry blending by using a Henschel mixer.

### Paraffin Wax (B)

The thermoplastic composition of the present invention can include the paraffin wax (B). Based on the acrylate-based rubber modified resin composition (A) as 100 parts by weight, an amount of the paraffin wax (B) is 0.05 part by weight to 10 parts by weight, preferably 2 parts by weight to 8 parts by weight, and more preferably 3 parts by weight to 6 parts by weight. If the amount of the paraffin wax (B) falls below 0.05 part by weight, chemical resistance, mobility and low gloss of the molding product obtained cannot be enhanced, and may lead to odor susceptibility on the surfaces of the molding product. Conversely, if the amount of the paraffin wax (B) exceeds 10 parts by weight, it will detrimentally impact the formability of the resulting molded product and increase the susceptibility of molds to contamination.

The paraffin wax (B) of the present invention is a saturated hydrocarbon derived from petroleum lubricants distillate. The purification process involves the removal of impurities such as aromatic hydrocarbon and sulfide compounds using anhydrous sulfuric acid or fuming sulfuric acid.

Molecular weight of the paraffin wax (B) can be defined by kinematic viscosity. The paraffin wax (B) of the present invention can be obtained by measuring the kinematic viscosity with a standard method of JIS K2283, for example, in which the kinematic viscosity at 40° C. of the paraffin wax (B) can be 0.1 mm²/sec to 78 mm²/sec, and 1 mm²/sec to 40 mm²/sec is preferable. The paraffin wax (B) has a weight average molecular weight in a range of 150 g/mole to 500 g/mole, preferably 180 g/mole to 450 g/mole, and more preferably 200 g/mole to 350 g/mole. Moreover, the weight average molecular weight can be determined by extracting weight average of various components with respective molecular weight in the paraffin wax (B) by gas chromatography, for example. In contrast to utilizing the paraffin wax with higher viscosity or molecular weight, employing the paraffin wax (B) within the specified viscosity or molecular range can effectively enhance the plasticization, processability, and chemical resistance of the resulting thermoplastic composition and molding products. Preferably, the utilization of the paraffin wax (B) with the viscosity exceeding 0.1 mm²/sec or the weight average molecular weight surpassing 150 g/mole can effectively suppress contamination of modules during the molding process of the thermoplastic composition and prevent defects in the thermoplastic composition that may result in surface imperfections of the molding product.

The paraffin wax (B) of the present invention is not specifically limited, and it is fine for the paraffin wax (B) to have a melting point below 75° C. In some examples, the paraffin wax (B) may include petroleum wax such as microcrystalline wax, petrolatum, and etc., synthetic wax of Fischer-Tropsch, or mineral wax such as montan wax. In order to enhance the processability and chemical resistance of the molding product of the thermoplastic composition, the paraffin wax (B) is preferred to be the petroleum wax. Preferably, an oil content of the paraffin wax (B) is 0.5% to 2.0%, preferably 0.5% to 1.5%, and more preferably 0.5% to 1.0%.

The paraffin wax (B) of the present invention is not specifically limited, and it is usually obtained by separating and refining distillate of petroleum from reduced pressure distillation. The aforementioned paraffin wax (B) can be used in quantity of one, or combination of two or more.

Preferably, the paraffin wax (B) of the present invention can include saturated chain hydrocarbons with a carbon number of 17 to 50. The saturated chain hydrocarbons is preferred to have 17 or more carbon atoms; the carbon atoms of the saturated chain hydrocarbons is preferred to be lower than 50, and lower than 45 is more preferable. The saturated chain hydrocarbons can be linear or branched. Preferably, the paraffin wax (B) is saturated branched hydrocarbons.

A melting point of the paraffin wax (B) can exceed 40° C., preferably higher than 45° C., and more preferably 48° C.; the melting point of the paraffin wax (B) is lower than 75° C., preferably lower than 70° C., and more preferably lower than 65° C. If the melting point of the paraffin wax (B) is greater than 40° C., sticky defects on a surface of the molding product of the thermoplastic composition can be avoided. If the melting point of the paraffin wax (B) is lower than 75° C., the processability of the molding product of the thermoplastic composition can be increased, and cracking defects in the molding product of the thermoplastic composition over time can be suppressed. The melting product of the paraffin wax (B) can be measured according to standard method of JIS K2235 5.3(1991).

Hindered amine light stabilizing composition with a dipiperidine structure (C1)

The hindered amine light stabilizing composition (C1) of the present invention comprises a compound with a dipiperidine structure, containing at least an alkyl group at position 2 and position 6, respectively, and lacking any saturated ester moieties or unsaturated ester moieties with carbon number of 12 to 21 at one of the positions 3, 4 or 5. The hindered amine light stabilizing composition with the dipiperidine structure (C1) has a molecular weight of 200 g/mole to 600 g/mole. The appropriate hindered amine light stabilizing composition with the dipiperidine structure (C1) comprises two compounds with the piperidine structure, wherein the two piperidine structures are connected by the saturated or unsaturated diester groups with a carbon number ranging from 3 to 11 at one of the positions 3, 4 or 5.

Preferably, the hindered amine light stabilizing composition with the dipiperidine structure (C1) comprises two compounds with the piperidine structure, and the two piperidine structures are connected by the saturated diester group with the carbon number ranging from 3 to 11, especially the carbon number of 6 to 10. The saturated diester group is connected at positions 3, 4 or 5 of the piperidine structure, and lacking saturated or unsaturated ester group with the carbon number of 12 to 21 is included at one of the positons 3, 4 or 5 of the piperidine structure.

In some embodiments, the hindered amine light stabilizing composition (C1) suitable for the present invention is preferably the hindered amine light stabilizing composition with the dipiperidine structure (C1) with the following formula (I).

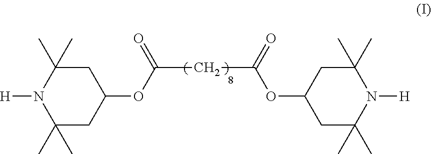

Such sterically hindered amine (bis(2,2,6,6-tetramethyl-4-piperidyl)sebacate, GAS No. 52829-07-9) and method of forming the same is known for those skilled in the art, and it is disclosed in literature, such as U.S. Pat. No. 4,396,769 and references cited therein. The hindered amine light stabilizing composition with the dipiperidine structure (C1) as shown in formula (I) can be, for example, made from BASE SE company, and the product of product model is Tinuvin® 770 (with molecular weight of 481 g/mole).

In some embodiments, other suitable examples suitable for the hindered amine light stabilizing composition with the dipiperidine structure (C1) of the present invention include bis(1,2,2,6,6-pentamethyl-4-piperidinyl) sebacate (CAS No. 41556-26-7, produced by BASF SE company, product of product model Tinuvin® 765, and molecular weight (M_{w}) is 509 g/mole); N-[6-[formyl-(2,2,6,6-tetramethylpiperidin-4-yl)amino]hexyl]-N-(2,2,6,6-tetramethylpiperidin-4-yl)formamide (CAS No. 124172-53-8, produced by BASF SE company, product model is Uvinul® 4050 H, and molecular weight (M_{w}) is 450 g/mole); N,N′-Bis(2,2,6,6-tetramethyl-4-piperidinyl)-1,3-benzenedicarboxamide (CAS No. 42774-15-2, produced by Clariant, product model is Ny-Iostab® S-EED®, and molecular weight (M_{w}) is 443 g/mole).

Based on the acrylate-based rubber modified resin composition (A) as 100 parts by weight, an amount of the hindered amine light stabilizing composition with a dipiperidine structure (C1) is 0.1 part by weight to 2 parts by weight, preferably 0.4 part by weight to 1.5 parts by weight, and more preferably 0.8 part by weight to 1.2 parts by weight.

In some embodiments, a weight ratio between the paraffin wax (B) and the hindered amine light stabilizing composition with a dipiperidine structure (C1) is 0.025 to 100, preferably 0.1 to 80, and more preferably 1 to 50. When the weight ratio of between the paraffin wax (B) and the hindered amine light stabilizing composition with a dipiperidine structure (C1) is in the aforementioned range, odor of the thermoplastic composition can be reduced, and enhance chemical resistance, mobility and low gloss.

### Hindered Amine Light Stabilizing Composition (C2)

The hindered amine light stabilizing composition (C2) of the thermoplastic composition of the present invention comprises compounds characterized by polymer structures. The polymer structures contain a piperidine group, in which the piperidine group is equipped with at least one alkyl group at positions 2 and 6, respectively, and doesn't contain any saturated ester moieties or unsaturated ester moieties with carbon number of 12 to 21 at one of the positions 3, 4 or 5. The hindered amine light stabilizing composition (C2) with the polymer structures is characterized by including at least two repeating units derived from polymerizable monomers, and at least three repeating units derived from polymerizable monomers is preferable. The molecular weight of the hindered amine light stabilizing composition (C2) with the polymer structures is typically between 1000 g/mole to 5000 g/mole, preferably 1500 g/mole to 5000 g/mole, and more preferably 2000 g/mole to 5000 g/mole.

In some embodiments, the suitable hindered amine light stabilizing composition (C2) having the polymer structures for the present invention preferably includes structures shown as following formula (II) and/or formula (III). In the formula (II), n represents integral of 2 to 20.

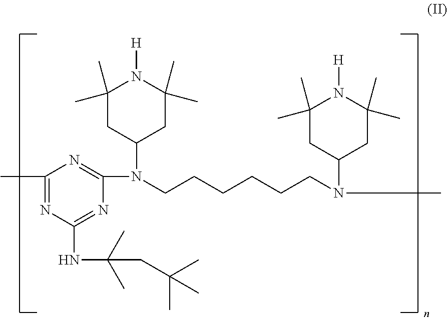

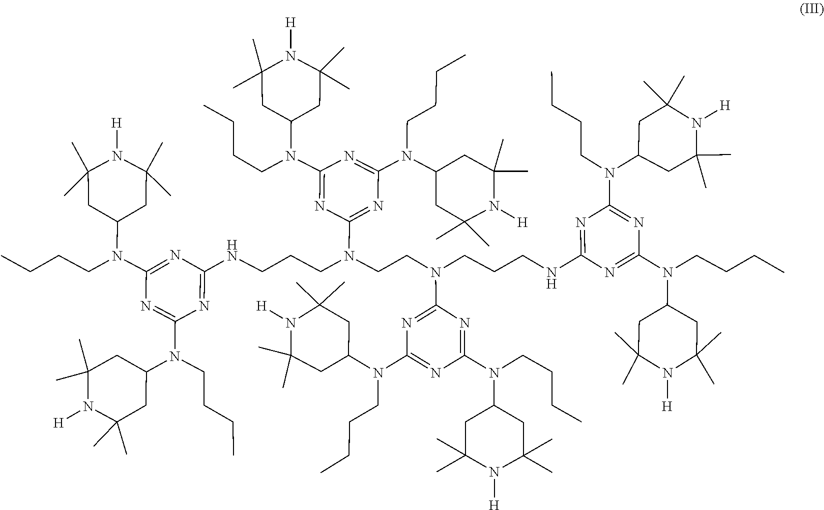 [SMILES: CCCCN(c1nc(NCCCN(CCN(CCCNc2nc(N(CCCC)C3CC(C)(C)NC(C)(C)C3)nc(N(CCCC)C3CC(C)(C)NC(C)(C)C3)n2)c2nc(N(CCCC)C3CC(C)(C)NC(C)(C)C3)nc(N(CCCC)C3CC(C)(C)NC(C)(C)C3)n2)c2nc(N(CCCC)C3CC(C)(C)NC(C)(C)C3)nc(N(CCCC)C3CC(C)(C)NC(C)(C)C3)n2)nc(N(CCCC)C2CC(C)(C)NC(C)(C)C2)n1)C1CC(C)(C)NC(C)(C)C1]

In some embodiments, the hindered amine light stabilizing composition (C2) having the polymer structures of piperidene groups is suitable for the present invention. The preferable hindered amine light stabilizing composition (C2) with CAS No. 71878-19-8 and its method of forming the same are known for those skilled in the art, and it is disclosed in literature, such as Europe patent with patent number of EP0093693B1 and references cited therein. The hindered amine light stabilizing composition having the polymer structures of piperidene groups as shown in the formula (II) can be for example, made from BASF SE company, and the product of product model is Chimassorb® 944 (with molecular weight of 2100 g/mole to 3000 g/mole). The hindered amine light stabilizing composition having the polymer structures of piperidene groups as shown in the formula (III) can be for example, made from SABO S.p.A company, and the product of product model is Sabostab® UV 119 (with molecular weight of 2286 g/mole, and CAS No. of 106990-43-6), or made from BASF SE company, and the product of product model is Chimassorb® 119.

In some embodiments, based on the acrylate-based rubber modified resin composition (A) as 100 parts by weight, an amount of the hindered amine light stabilizing composition (C2) with the formula (III) can be 0.1 part by weight to 1.0 part by weight, preferably 0.1 part by weight to 0.8 part by weight, and more preferably 0.3 part by weight to 0.6 part by weight. When the amount of the hindered amine light stabilizing composition (C2) with the formula (III) falls within the aforementioned range, odor of the thermoplastic composition can be reduced, and enhance its chemical resistance, mobility and reduced gloss.

Examples of the hindered amine light stabilizing composition (C2) can include but are not limited to: N,N′-bis(2,2,6,6-tetramethyl-4-piperidinyl)-1,6-hexanediamine polymer with 2,4,6-trichloro-1,3,5-triazine reaction products with N-butyl-1-butanamine and N-butyl-2,2,6,6-tetramethyl-4-piperidinamine (CAS No. 192268-64-7, made from BASF SE company, and marketed under the product model name Chimassorb® 2020, and molecular weight is 2600 g/mole to 3400 g/mole); polymer of dimethyl succinate and 4-hydroxy-2,2,6,6-tetramethyl-1-piperidine ethanol (CAS No. 65447-77-0, made from BASF SE company, and marketed under the product model name Tinuvin® 622, and M_{w} is 3100 g/mole to 4000 g/mole); reaction products of alkenes, C20-24-alpha-polymers with maleic anhydride, with 2,2,6,6-tetramethyl-4-piperidinamine (CAS No. 152261-33-1, made from BASF SE company, and marketed under the product model name Uvinul® 5050H, and M_{w} is 3000 g/mole to 4000 g/mole); 1,3,5-triazine-2,4, 6-triamine,N2,N2″-1,2-ethanediylbis[N2-[3-[4,6-bis[butyl(1,2,2,6,6-pentamethyl-4-piperidinyl)amino]-1,3,5-triazin-2-yl]amino]propyl]-N′,N″-dibutyl-N′,N″-bis(1,2,2,6,6-pentamethyl-4-piperidinyl) (CAS No. 106990-43-6, made from SABO S.p.A company, and marketed under the product model name Sabostab® UV 119, and M_{w} is 2286 g/mole); Poly[(6-morpholino-s-triazine-2,4-diyl) [2,2,6,6-tetramethyl-4-piperidyl]imino]-hexa-methylene[(2,2,6,6-tetramethyl-4-piperidyl) imino]] (CAS No. 82451-48-7 or 90751-07-8, made from Solvay company, and marketed under the product model name Cyasorb® UV-3346, and M_{w} is 1600 g/mole); reaction products of N,N′-bis(2,2,6,6-tetramethyl-4-piperidinyl)-1,6-hexanediamine polymers with morpholine-2,4,6-trichloro-1,3,5-triazine (CAS No. 193098-40-7 or 219920-30-6, made from Solvay company, and marketed under the product model name Cyasorb® UV-3529).

Based on the acrylate-based rubber modified resin composition (A) as 100 parts by weight, an amount of the hindered amine light stabilizing composition (C2) is 0.1 part by weight to 1.6 parts by weight, preferably 0.3 part by weight to 1.4 parts by weight, and more preferably 0.5 part by weight to 1.2 parts by weight.

A weight ratio between the hindered amine light stabilizing composition with a dipiperidine structure (C1) and the hindered amine light stabilizing composition (C2) can be 0.06 to 20, preferably 0.1 to 15, and more preferably 0.5 to 10. When the weight ratio between the hindered amine light stabilizing composition with a dipiperidine structure (C1) and the hindered amine light stabilizing composition (C2) is in the aforementioned range, odor of the thermoplastic composition can be reduced, and enhance its chemical resistance, mobility and reduced gloss.

### Ultraviolet Light Stabilizing Composition (D)

Examples of the ultraviolet light stabilizing composition (D) of the present invention can include but are not limited to benzophenone compounds (such as 2-hydroxybenzophenone), benzotriazole compounds (such as 2-(2-hydroxyphenyl)-benzotriazole, triazine compounds, hydroxyphenyl triazine compounds (such as 2-(2-hydroxyphenyl)-1,3,5-triazine), oxanilide, salicylate, cinnamate, nickel chelate, phenolic antioxidants, other hindered amine compounds not belong to the aforementioned hindered amine light stabilizing composition with a dipiperidine structure (C1) and the hindered amine light stabilizing composition (C2), hydroxylamine, bifunctional compounds, other suitable ultraviolet light stabilizing compositions, or combinations thereof.

For example, the aforementioned ultraviolet light stabilizing composition (D) can include but are not limited to compounds with CAS No. 2440-22-4, 3147-75-9, 3896-11-5, 3846-71-7, 23328-53-2, 25973-55-1, 36437-37-3, 3864-99-1, 70321-86-7, 103597-45-1 or 84268-08-6, or combinations thereof.

Preferably, the ultraviolet light stabilizing composition (D) can be products with product model of Tinuvin® 329 (CAS No. 3147-75-9), Tinuvin® 234 (CAS No. 70321-86-7) or Tinuvin® 360 (CAS No. 103597-45-1).

In an embodiment of the present invention, the ultraviolet light stabilizing composition (D) can be 2-(2′-hydroxy-5′-tert-octylphenyl)benzotriazole or 2,2′-methylenebis[6-(benzotriazol-2-yl)-4-tert-octylphenol] (Tinuvin® 360).

Based on the acrylate-based rubber modified resin composition (A) as 100 parts by weight, an amount of the ultraviolet light stabilizing composition (D) is 0.1 part by weight to 1.5 parts by weight, preferably 0.1 part by weight to 1.3 parts by weight, and more preferably 0.3 part by weight to 1.0 parts by weight.

A weight ratio between the hindered amine light stabilizing composition with a dipiperidine structure (C1) and the ultraviolet light stabilizing composition (D) can be 0.06 to 20, preferably 0.1 to 15, and more preferably 0.5 to 10. When the weight ratio between the hindered amine light stabilizing composition with a dipiperidine structure (C1) and the ultraviolet light stabilizing composition (D) is in the aforementioned range, odor of the thermoplastic composition can be reduced, and enhance its chemical resistance, mobility and reduced gloss.

Coloring Agent, a Dye and/or a Pigment (E)

As described above, the thermoplastic composition of the present invention can further include a coloring agent, a dye and/or a pigment (E) in 0.1 part by weight to 10 parts by weight, and usually in 0.1 part by weight to 5 parts by weight, which can be added in form of masterbatch, and the masterbatch includes polymer matrix and other coloring agent, dyes and/or a pigment. In some embodiments, the coloring agent, dyes and/or a pigment are added in the forms of masterbatch, and based on total amounts of the masterbatch, the masterbatch includes 20 wt % to 70 wt % of the coloring agent, the dye and/or the pigment, or mixtures of the coloring agent, the dye and/or the pigment and 30 wt % to 80 wt % of copolymer of vinylaryl alkene and acrylonitrile as polymer matrix. Preferably, the polymer matrix is selected from styrene-acrylonitrile copolymers (SAN), α-methylstyrene-acrylonitrile copolymers (AMSAN) and/or styrene-methyl methacrylate copolymers (SMMA).

In some examples, the pigment can include but are not limited to titanium dioxide, phthalocyanine, ultramarine, ferric oxide and carbon black, and all organic pigments. The coloring agent can include but are not limited to all dyes used in transparent, semi-transparent or opaque coloring for the polymers, especially suitable coloring dyes for the styrene copolymers.

### Other Additives (F)

The thermoplastic composition of the present invention can optionally include one or more other additives (F), and the other additives (F) are not any additives of the acrylate-based rubber modified resin composition (A), the paraffin wax (B), the hindered amine light stabilizing composition with a dipiperidine structure (C1), the hindered amine light stabilizing composition (C2), the ultraviolet light stabilizing composition (D), and the coloring agent, the dye and/or the pigment (E) discussed above. For example, the other additives (F) are selected from plasticizers, aliphatic amide wax, aliphatic acid esters, and other ultraviolet light stabilizing composition not belonging to the ultraviolet light stabilizing composition (D).

Optionally, various additives can be added into the thermoplastic composition as an auxiliary and/or a processing additive in 0.05 part by weight to 5 parts by weight, and usually in 0.1 part by weight to 5 parts by weight. The suitable other additives (F) include all substances generally used in processing or treatment of the polymers.

The other additives (F) can be added in forms of materbatch containing the other additives (F) in the polymer matrix. In some embodiments, the other additives (F) are added in the forms of masterbatch, and based on total amounts of the masterbatch, the masterbatch includes 20 wt % to 70 wt % of the other additives (F), preferably is 40 wt % to 60 wt %, or its mixtures of 30 wt % to 80 wt % preferably is 40 wt % to 60 wt % (based on the total amounts of the masterbatch) of the copolymer of vinylaryl alkene and acrylonitrile as the polymer matrix. Preferably, the polymer matrix is selected from styrene-acrylonitrile copolymers (SAN), α-methylstyrene-acrylonitrile copolymers (AMSAN) and/or styrene-methyl methacrylate copolymers (SMMA).

Examples of the other additives (F) can be antistatic agents, antioxidants, flame retardants, stabilizers used for increasing thermal stability, stabilizers used for increasing photostability, anti-thermal decomposition agents or lubricants, especially lubricants, which is advantageous for producing the molding products. These other additives (F) to be further added can be mixed at any stages in processing operations, but it is preferably added at early stages to early develop stable effects (or other specific effects) of the other additives (F).

Examples of the suitable antistatic agents can include but are not limited to amine derivatives (such as N,N-bis(hydroxyalkyl)alkyl amine or alkylidene amine), polyethylene glycol ester, copolymers of ethylene oxide and propylene epoxide (especially diblock or triblock of ethylene oxide and block of propylene epoxide), glycerol monostearate, glycerin distearate and mixtures thereof.

Examples of suitable antioxidants can include but are not limited to steric hindered monophenol or polyphenol antioxidants, which can include various substituents and can crosslinked by substituents. The antioxidants not only include monomers, but also include oligomers composed of plural phenol units. Hydroquinone and similar compounds thereof are also the suitable antioxidants, their substituted compounds and antioxidants based on tocopherol and its derivatives are also suitable. The used antioxidants can include mixtures composed of different antioxidants. In principal, any commercial or suitable compounds for styrene copolymers can be used, such as antioxidants from Irganox® series. In addition to the aforementioned examples of phenol antioxidants, co-stabilizers can be used, especially co-stabilizers including phosphorous or sulfur, and the co-stabilizers including phosphorous or sulfur are known for those skilled in the art.

Example of the suitable flame retardants include compounds including halogens or including phosphorous, magnesium hydroxide and other common flame retardants or mixtures thereof known for those skilled in the art.

Examples of the suitable photostabilizers include various substituted meta-dihydroxybenzene, salicylates, benzotriazole and benzophenone.

Suitable matting agents not only include inorganic matters such as talc, glass bead or metal carbonates (such as MgCO₃ or CaCO₃, and etc.), but also include polymer particles (such as sphere particles having diameter D50 greater than 1 μm of methyl methacrylate, styrene compounds, acrylonitrile or mixtures thereof). The matting agents can also use polymers including copolymer of acidic and/or alkaline monomer.

Examples of the suitable anti-drip can include Teflon polymer and ultra-high molecular weight styrene (weight average molecular weight (M_{w}) greater than 2000000 g/mole).

Examples of fibrous/flour filler can include carbon or glass fiber, whose form can be glass fabric, glass pad or filament glass yarn, chopped glass, glass bead and wollastonite, and the glass fiber is preferable. When the glass fiber is used, a sizing agent and a coupling agent can be used for treatment, thereby increasing compatibility of which and its mixing composition. The doped glass fiber can use the forms of short glass fiber or continuous filament (rove).

Examples of suitable particle fillers can include amorphous silicon dioxide, magnesium carbonates, quartz powders, mica, bentonite, talc, feldspar or calcium silicate, such as wollastonite and kaolinite.

Examples of the suitable stabilizers include hindered phenol and vitamin E and/or compounds with similar structures, and butylated product of p-cresol and dicyclopentadiene. Other hindered amine light stabilizing composition other than the hindered amine light stabilizing composition with a dipiperidine structure (C1) and the hindered amine light stabilizing composition (C2), benzophenone, meta-dihydroxybenzene, salicylates or benzotriazole are also the suitable stabilizers. For example, other suitable compounds can be thiocarboxylic esters, which can also use alkyl ester of thiopropionic acid with carbon number of 6 to 20, especially cholesteryl stearate and laurate.

Dilauryl thiodipropionate, distearyl thiodipropionate or mixtures thereof can also be used. Examples of the other additives can include the ultraviolet light stabilizing composition (D), such as 2-(2H-Benzotriazol-2-yl)-4-Methylphenol.

The suitable lubricants and release agents include stearic acid, stearyl alcohol, cholesteryl stearate and/or typical higher fatty acid, their derivatives and mixtures of corresponding fatty acids with carbon number of 1 to 45. Preferably, in some embodiments, the composition includes amide compounds with formula R₁—CONH—R₂, in which R₁ and R₂ are individually selected from aliphatic hydrocarbons, saturated hydrocarbons or unsaturated hydrocarbons with carbon number of 1 to 30. Preferably, R₁ and R₂ individually represents aliphatic hydrocarbons, saturated hydrocarbons or unsaturated hydrocarbons with carbon number of 12 to 24, and more preferably, represents aliphatic hydrocarbons, saturated hydrocarbons or unsaturated hydrocarbons with carbon number of 16 to 20. In some embodiments, the composition can additionally include aliphatic ester compounds with formula R₃—CONH—R₄, in which R₃ and R₄ are individually selected from aliphatic hydrocarbons, saturated hydrocarbons or unsaturated hydrocarbons with carbon number of 1 to 45. Preferably, R₃ and R₄ individually represents aliphatic hydrocarbons, saturated hydrocarbons or unsaturated hydrocarbons with carbon number of 15 to 40, and more preferably, represents aliphatic hydrocarbons, saturated hydrocarbons or unsaturated hydrocarbons with carbon number of 25 to 35. Ethylene bis(stearamide) is especially suitable.

In some embodiments, the thermoplastic composition of the present invention can include organic, inorganic or mixing phosphates, especially alkaline metal or alkaline-earth metal phosphates such as Ca₃(PO₄)₂ and or organic phosphates including alkyl group or aryl group with carbon number of 1 to 12.

In some embodiments, the thermoplastic composition of the present invention further includes polyester-modified polysiloxanes, especially polyester-polysiloxane-block copolymer, and (polyester-b-polysiloxane-b-polyester) triblock copolymer is preferable. Examples of the polysiloxane portion in the polyester-polysiloxane-block copolymer can be derivatives of polydimethylsiloxane, polydiethylsiloxane, polydipropylsiloxane, polydibutylsiloxane and mixtures thereof.

The method for producing the thermoplastic composition of the present invention is not specifically limited, which can use general mixing method, such as mixing the acrylate-based rubber modified resin composition (A), the paraffin wax (B) and the hindered amine light stabilizing composition with a dipiperidine structure (C1) homogeneously, and optionally adding the hindered amine light stabilizing composition (C2); the ultraviolet light stabilizing composition (D); and the coloring agent, the dye and/or the pigment (E); and/or other additives (F). In some embodiments, the normal mixing method can include melt mixing by a mixer such as an extrusion mixer, a kneader reactor or a Banbury mixer after dry blending by using a Henschel mixer.

In some embodiments, the method for producing the thermoplastic composition of the present invention is to provide 100 parts by weight of the acrylate-based rubber modified resin composition (A), 0.05 part by weight to 10 parts by weight of the paraffin wax (B) and 0.1 part by weight to 2 parts by weight of the hindered amine light stabilizing composition with a dipiperidine structure (C1), and then compounding under temperature of 200° C. to 230° C.

In addition, the hindered amine light stabilizing composition (C2); the ultraviolet light stabilizing composition (D); and the coloring agent, the dye and/or the pigment (E); and/or other additives (F) can be added to the thermoplastic composition of the present invention according to requirement. For example, the other additives (F) can include but are not limited to antioxidants, plasticizers, processing additives, ultraviolet light stabilizing compositions different from the ultraviolet light stabilizing composition (D), ultraviolet absorbers, fillers, reinforcing agents, coloring agents, lubricants, antistatic additives, flame retardants, flame retarding auxiliary, thermal stabilizers, coupling agents or other additives, and etc. The aforementioned additives can be added during extrusion kneading process.

Another aspect of the present invention provides a molding product, which is formed by using the aforementioned thermoplastic composition. The method of forming the molding product can use injection molding known for those skilled in the art. Therefore, it is not repeated herein.

The following Embodiments are provided to better elucidate the practice of the present invention and should not be interpreted in anyway as to limit the scope of same. Those skilled in the art will recognize that various modifications may be made while not departing from the spirit and scope of the invention. All publication and patent applications mentioned in the specification are indicative of the level of those skilled in the art to which this invention pertains.

### Embodiment 1

### Production of the Styrene-Acrylonitrile Copolymers

68 parts by weight of the styrene monomers, 32 parts by weight of the acrylonitrile monomers, 8 parts by weight of ethylbenzene, 0.01 part by weight of 1,1-di-(tert-butylperoxy)-3,3,5-trimethylcyclohexane, and 0.15 part by weight of tert-dodecyl-mercaptan were mixed homogeneously, and were provided to two parallel continuous stirred tank reactors continuously. Both of the reactors had volume of 40 liters, and internal temperatures of two of the reactors remained at 110° C. and 115° C., respectively, while pressures of the reactors were both 4 kg/cm². Homogeneously mixed raw materials were provided to the reactors with a feeding rate of 35 kg/hr, thereby performing the polymerization reaction. Conversion rate of the whole polymerization reaction was about 50%.

After the polymerization reaction, the obtained copolymer solution is heated by a preheater, and then unreacted monomers and other volatile components were removed by volatilization in a depressurized degassing tank. Finally, the styrene-acrylonitrile copolymers of embodiment 1 could be obtained by extruding granulation.

### Production of the Acrylate-Based Rubber Grafted Copolymers

First, 99 parts by weight of the butyl acrylate, 1.0 part by weight of the allyl methacrylate, 5.0 parts by weight of the sodium di-n-octyl sulfosuccinate, 2.0 parts by weight of the tert-butyl hydroperoxide solution (in concentration of 70 wt %), 3.0 parts by weight of the ferrous sulfate solution (in concentration of 0.2 wt %), 3.0 parts by weight of sodium formaldehydesulfoxylate solution (in concentration of 10 wt %) and 4000 parts by weight of distilled water were reacted under the reaction temperature of 60° C. for 7 hours, thereby obtaining the acrylate-based rubber emulsion with the weight average particle size of 0.1 μm.

Subsequently, 100.0 parts by weight of the above acrylate-based rubber emulsion with the weight average particle size of 0.1 μm (dry weight), 70.0 parts by weight of the styrene, 30.0 parts by weight of the acrylonitrile, 6.0 parts by weight of the sodium di-n-octyl sulfosuccinate, 1.0 part by weight of cumene hydroperoxide, 3.0 parts by weight of the ferrous sulfate solution (in concentration of 0.2 wt %), 3.0 parts by weight of the sodium formaldehydesulfoxylate solution (in concentration of 10 wt %) and 3000.0 parts by weight of distilled water were mixed, and were performed the grafting polymerization reaction, in which the styrene and the acrylonitrile were added continuously into a reaction system in 5 hours. When the grafting polymerization reaction was completed, the acrylate-based rubber grafted emulsion with the weight average particle size of 0.12 μm could be obtained.

Additionally, 99 parts by weight of the butyl acrylate, 1.0 part by weight of the allyl methacrylate, 3.0 parts by weight of the sodium di-n-octyl sulfosuccinate, 1.0 parts by weight of the tert-butyl hydroperoxide solution (in concentration of 70 wt %), 3.0 parts by weight of the ferrous sulfate solution (in concentration of 0.2 wt %), 3.0 parts by weight of sodium formaldehydesulfoxylate solution (in concentration of 10 wt %) and 4000.0 parts by weight of distilled water were reacted under the reaction temperature of 65° C. for 7 hours, thereby obtaining the acrylate-based rubber emulsion with the weight average particle size of 0.4 μm.

Likewise, 100.0 parts by weight of the above acrylate-based rubber emulsion with the weight average particle size of 0.4 μm (dry weight), 37.6 parts by weight of the styrene, 16.1 parts by weight of the acrylonitrile, 4.0 parts by weight of the sodium di-n-octyl sulfosuccinate, 1.0 part by weight of cumene hydroperoxide, 3.0 parts by weight of the ferrous sulfate solution (in concentration of 0.2 wt %), 3.0 parts by weight of the sodium formaldehydesulfoxylate solution (in concentration of 10 wt %) and 2000.0 parts by weight of distilled water were mixed, and were performed the grafting polymerization reaction, in which the styrene and the acrylonitrile were added continuously into a reaction system in 5 hours. When the grafting polymerization reaction was completed, the acrylate-based rubber grafted emulsion with the weight average particle size of 0.45 μm could be obtained.

Finally, 60 wt % (dry weight) of the acrylate-based rubber grafted emulsion with the weight average particle size of 0.12 μm and 40 wt % (dry weight) of the acrylate-based rubber grafting emulsion with the weight average particle size of 0.45 μm were mixed, and were further dried until moisture content lower than 2% after condensation and dehydration by using calcium chloride (CaCl₂), thereby obtaining the acrylate-based rubber grafted copolymers of the embodiment 1, which had the weight average particle size in the bimodal distribution with peaks at 0.12 μm and 0.45 μm.

### Production of the Acrylate-Based Rubber Modified Resin Composition

Under dry conditions, an acrylate-based rubber modified resin composition was prepared by compounding 65.1 wt % of the above styrene-acrylonitrile copolymers, 34.9 wt % of the acrylate-based rubber grafted copolymers (with the weight average particle size in the bimodal distribution with peaks at 0.12 μm and 0.45 μm), and 1.04 wt % of the lubricant were compounded at a temperature of 220° C. by a double screw extruder. Then, after extruding by the double screw extruder, the desired acrylate-based rubber modified resin composition could be obtained.

### Production of the Thermoplastic Composition

Under dry condition, 100 parts by weight of acrylate-based rubber modified resin composition, 1.0 part by weight of Tinuvin®770, 2 parts by weight of the paraffin wax and 1.6 parts by weight of the carbon black were compounded at a temperature of 220° C. by the double screw extruder. Then, after extruding by the double screw extruder, the thermoplastic composition of embodiment 1 could be obtained.

### Embodiments 2-6

The differences between embodiments 2-6 and embodiment 1 were only that the types and/or amount of paraffin wax (B) used in the production of the thermoplastic composition. The detailed composition is shown in table 1. In addition, embodiments 2-6 followed the same producing method as embodiment 1.

### Embodiments 7-9

The only differences between embodiments 7-9 and embodiment 1 were the addition of the hindered amine light stabilizing composition (C2) with molecular weight of 1000 g/mole to 5000 g/mole or the ultraviolet light stabilizing composition (D) during the producing the thermoplastic composition. The detailed composition is shown in table 1. In addition, embodiments 7-9 followed the same producing method as embodiment 1.

### Embodiment 10

The only differences between embodiment 10 and embodiment 1 were the addition of the hindered amine light stabilizing composition (C2) with molecular weight of 1000 g/mole to 5000 g/mole and the ultraviolet light stabilizing composition (D) during the production of the thermoplastic composition. The detailed composition is shown in table 1. In addition, embodiment 10 followed the same producing method as embodiment 1.

### Comparative Examples 1, 3 and 4

The only differences between comparative examples 1, 3 and 4 and embodiment 1 were that the thermoplastic composition was produced without using the paraffin wax (B). The detailed composition is shown in table 1. In addition, comparative examples 1, 3 and 4 followed the same producing method as embodiment 1.

### Comparative Example 2

The only differences between comparative example 2 and embodiment 1 were that the thermoplastic composition was produced without adding the hindered amine light stabilizing composition with a dipiperidine structure (C1) with the molecular weight of 200 g/mole to 600 g/mole. The detailed composition is shown in table 1. In addition, comparative example 2 followed the same producing method as embodiment 1.

### Comparative Example 5

The only differences between comparative example 5 and embodiment 1 were that the thermoplastic composition was produced without adding the hindered amine light stabilizing composition with a dipiperidine structure (C1) with the molecular weight of 200 g/mole to 600 g/mole. The detailed composition is shown in table 1. In addition, comparative example 5 followed the same producing method as embodiment 1.

### Embodiments 11 and 14

The differences between embodiments 11 and 14 and embodiment 1 were only in the types and/or amount of the paraffin wax (B) used. Additionally, the ultraviolet light stabilizing composition (D) was further added during the production of the thermoplastic composition. The detailed composition was shown in table 2. In addition, embodiments 11 and 14 followed the same producing method as embodiment 1.

### Embodiments 12 and 13

The differences between embodiments 12 and 13 and embodiment 1 were only in the types and/or amount of the paraffin wax (B) used. Additionally, the hindered amine light stabilizing composition (C2) with molecular weight of 1000 g/mole to 5000 g/mole and the ultraviolet light stabilizing composition (D) were further added during the production of the thermoplastic composition. The detailed composition is shown in table 2. In addition, embodiments 12 and 13 followed the same producing method as embodiment 1.

### Embodiments 15-17

The only differences between embodiments 15-17 and embodiment 1 were the varying amounts of the styrene-acrylonitrile copolymers and the acrylate-based rubber grafted copolymers, the types and/or amount of the paraffin wax (B) used. Additionally, the hindered amine light stabilizing composition (C2) with molecular weight of 1000 g/mole to 5000 g/mole and the ultraviolet light stabilizing composition (D) were further added during the production of the thermoplastic composition. The detailed composition is shown in table 2. In addition, embodiments 15-17 followed the same producing method as embodiment 1.

### Comparative Example 6

The only differences between comparative example 6 and embodiment 1 were the absence of paraffin wax (B) and additional inclusion of the ultraviolet light stabilizing composition (D) during the production of the thermoplastic composition. The detailed composition is shown in table 2. In addition, comparative example 6 followed the same producing method as embodiment 1.

### Comparative Example 7

The only differences between comparative example 7 and embodiment 1 were the absence of hindered amine light stabilizing composition with a dipiperidine structure (C1) with the molecular weight of 200 g/mole to 600 g/mole, and additional inclusion of the hindered amine light stabilizing composition (C2) with molecular weight of 1000 g/mole to 5000 g/mole and the ultraviolet light stabilizing composition (D) during the production of the thermoplastic composition. The detailed composition is shown in table 2. In addition, comparative example 7 followed the same producing method as embodiment 1.

The following outlines the principles and criteria used to evaluate the physical properties of the thermoplastic compositions in embodiments 1-17 and comparative examples 1-7. The testing results are shown in table 1 and table 2, respectively.

### Physical Properties Testing of the Thermoplastic Composition

### 1. Melt Volume Rate (MVR)

Testing was performed according to standard method of ASTM D-1238, in which testing temperature is 220° C., loading weight is 10 kg, and the MVR was presented in g/10 min.

### 2. Surface Gloss

The thermoplastic compositions of various embodiments and comparative examples were injection molded to disk pieces with diameter of 5.5 cm, which were tested according to standard method of ASTM D-523, with units in %.

### 3. Chemical Resistance

The chemical resistance of the thermoplastic compositions was evaluated by ¼ ellipse method, in which reagents were unleaded gasoline #95 and glacial acetic acid. In order to reduce impact of forming strain on test piece, the thermoplastic compositions of various embodiments and comparative examples were injection molded to produce ellipse test pieces for the chemical resistance. Sizes of the test pieces were 230 mm×30 mm×2 mm, while the ellipse had semi-major axis of was 190 mm and semi-minor axis of 77 mm.

The reagents were spread on the test pieces. Cracks of the test pieces were examined after placing at 23° C. for 48 hours. Critical strain of the test pieces was calculated using the following formula, and the chemical resistance was judged by the following criteria, in which “grade F” represented no cracking in daily use, “grade D” represented cracking occurs in daily use under high stress condition, and “grade C” represented cracking may occur in daily use.

$$ε = {\frac{b}{2 {a}^{2}} [ 1 - \frac{( {a}^{2} - {b}^{2} ) {X}^{2}}{{a}^{4}} ]}^{1.5} \times t \times 100$$

In the above formula, ε represents critical strain, a represents semi-major axis, b represents semi-minor axis, X represents cracking points, and t represents thickness of the test pieces.
Grade E: 2.0≤ε.
Grade D: 0.8≤ε<2.0.
Grade C: 0.5≤ε<0.8.

### 4. Odor Testing

10 g of the thermoplastic compositions of various embodiments and comparative examples were added into 500 ml glass bottles, and were heated in an oven with 70° C. After heating for 2 hours, they were cooled to room temperature for 0.5 hour to 1.5 hours, and then the odor testing was judged according to the following evaluation grades (grade 1 to grade 5).
Grade 1: odorless.
Grade 2: perceivable and acceptable slight odor.
Grade 3: with odor, but not irritating and tolerable.
Grade 4: obvious and offensive odor.
Grade 5: strong and intolerable irritating odor.

### 5. Processability

The processability was judged according to testing results of the MVR and the following criteria, in which ⊚ represents excellent processability, while ∘ represents great processability.
⊚: 11.5 g/10 min≤MVR.
∘: 9.5 g/10 min≤MVR<11.5 g/10 min.

TABLE 1

| | | | Embodi- | Embodi- | Embodi- | Embodi- | Embodi- | Embodi- | Embodi- | Embodi- |
|---|---|---|---|---|---|---|---|---|---|---|
| | | | ment 1 | ment 2 | ment 3 | ment 4 | ment 5 | ment 6 | ment 7 | ment 8 |
| Compostion | styrene-acrylonitrile | | 65.1 | 65.1 | 65.1 | 65.1 | 65.1 | 65.1 | 65.1 | 65.1 |
| (parts by | acrylate base rubber grafted | | 34.9 | 34.9 | 34.9 | 34.9 | 34.9 | 34.9 | 34.9 | 34.9 |
| wight) | copolymers | | | | | | | | | |
| | paraffin | B-1 | 2 | 4 | 6 | | | | 4 | 4 |
| | wax (B) | B-2 | | | | 2 | 4 | 6 | | |
| | hindered amine | C1-1 | 1.0 | 1.0 | 1.0 | 1.0 | 1.0 | 1.0 | 1.0 | 1.0 |
| | light stabilizer | | | | | | | | | |
| | with a | | | | | | | | | |
| | dipiperidine | | | | | | | | | |
| | structure (C1) | | | | | | | | | |
| | hindered amine | C2-1 | | | | | | | | |
| | light stabilizer | C2-2 | | | | | | | 0.5 | |
| | (C2) | | | | | | | | | |
| | ultraviolet light | D-1 | | | | | | | | 0.5 |
| | stabilizer (D) | | | | | | | | | |
| | coloring agent, | E-1 | 1.6 | 1.6 | 1.6 | 1.6 | 1.6 | 1.6 | 1.6 | 1.6 |
| | dyes and/or a | | | | | | | | | |
| | pigment (E) | | | | | | | | | |
| | other additives | F-1 | 1.04 | 1.04 | 1.04 | 1.04 | 1.04 | 1.04 | 1.04 | 1.04 |
| | (F) | | | | | | | | | |
| Evalution | MVR (g/10 min) | | 11.1 | 11.9 | 12.9 | 11.0 | 11.7 | 12.6 | 11.8 | 12.1 |
| results | gloss (%) | | 89.1 | 83.4 | 75.9 | 91.0 | 85.1 | 80.2 | 82.1 | 83.0 |
| | chemical | unleaded | D | E | E | D | E | E | E | E |
| | resistance | gasoline #95 | | | | | | | | |
| | | glacial acetic | D | E | E | D | E | E | E | E |
| | | acid | | | | | | | | |

| | | | | | | | | |
|---|---|---|---|---|---|---|---|---|
| odor testing | 1 | 1 | 1 | 1 | 1 | 1 | 1 | 1 |
| processability | ◯ | ⊚ | ⊚ | ◯ | ⊚ | ⊚ | ⊚ | ⊚ |

| | | Embodi- | Embodi- | Comparative | Comparative | Comparative | Comparative | Comparative |
|---|---|---|---|---|---|---|---|---|
| | | ment 9 | ment 10 | example 1 | example 2 | example 3 | example 4 | example 5 |
| Compostion | styrene-acrylonitrile | 65.1 | 65.1 | 65.1 | 65.1 | 65.1 | 65.1 | 65.1 |
| (parts by | acrylate base rubber grafted | 34.9 | 34.9 | 34.9 | 34.9 | 34.9 | 34.9 | 34.9 |
| wight) | copolymers | | | | | | | |

| | | | | | | | | |
|---|---|---|---|---|---|---|---|---|
| paraffin | B-1 | 4 | 4 | | 2 | | | 2 |
| wax (B) | B-2 | | | | | | | |
| hindered amine | C1-1 | 1.0 | 1.0 | 1.0 | | 1.0 | 1.0 | |
| light stabilizer | | | | | | | | |
| with a | | | | | | | | |
| dipiperidine | | | | | | | | |
| structure (C1) | | | | | | | | |
| hindered amine | C2-1 | 0.5 | 0.5 | | | | | 0.5 |
| light stabilizer | C2-2 | | 0.5 | | | | 0.5 | |
| (C2) | | | | | | | | |
| ultraviolet light | D-1 | | 0.5 | | | 0.5 | | 0.5 |
| stabilizer (D) | | | | | | | | |
| coloring agent, | E-1 | 1.6 | 1.6 | 1.6 | 1.6 | 1.6 | 1.6 | 1.6 |
| dyes and/or a | | | | | | | | |
| pigment (E) | | | | | | | | |
| other additives | F-1 | 1.04 | 1.04 | 1.04 | 1.04 | 1.04 | 1.04 | 1.04 |
| (F) | | | | | | | | |

| | | | | | | | | |
|---|---|---|---|---|---|---|---|---|
| Evalution | MVR (g/10 min) | 12.0 | 12.5 | 9.8 | 10.2 | 9.8 | 9.7 | 10.5 |
| results | gloss (%) | 82.0 | 82.6 | 94.4 | 91.2 | 94.0 | 94.5 | 91.1 |

| | | | | | | | | |
|---|---|---|---|---|---|---|---|---|
| chemical | unleaded | E | E | C | D | C | C | D |
| resistance | gasoline #95 | | | | | | | |
| | glacial acetic | E | E | D | D | D | D | D |
| | acid | | | | | | | |

| | | | | | | | |
|---|---|---|---|---|---|---|---|
| odor testing | 1 | 1 | 3 | 2 | 3 | 3 | 2 |
| processability | ⊚ | ⊚ | ◯ | ◯ | ◯ | ◯ | ◯ |

B-1: produced by Taiwan Wax Company, and the paraffin wax with product model of Taiwan wax 145F (with melting point of 62° C.).
B-2: produced by Taiwan Wax Company, and the paraffin wax with product model of Taiwan wax 160F (with melting point of 71° C.).
C1-1: produced by BASF SE Company, and the hindered amine light stabilizing composition with product model of Tinuvin® 770, and a molecular weight is ranging from 200 g/mole to 600 g/mole.
C2-1: the hindered amine light stabilizing composition produced by BASF SE Company with product model of Chimassorb® 119, and a molecular weight is ranging from 1000 g/mole to 5000 g/mole.
C2-2: the hindered amine light stabilizing composition produced by BASF SE Company with product model of Chimassorb® 944, and a molecular weight is ranging from 1000 g/mole to 5000 g/mole.
D-1: the ultraviolet light stabilizing composition produced by BASF SE Company with product model of Tinuvin® 329.
E-1: the carbon black produced by Orion Company with product model of Hi Black 890.
F-1: the lubricant produced by Palmamide Company with product model of Armowax EBS.

According to the data presented in table 1, in embodiments 1-6, the incorporation of acrylate-based rubber modified resin composition (i.e. the styrene-acrylonitrile copolymers and the acrylate-based rubber grafted copolymers), the paraffin wax (B) and Tinuvin® 770 into the thermoplastic compositions result in a reduction in odor, enhanced the mobility, improved chemical resistance, and decreased gloss of the thermoplastic compositions.

In embodiments 7-9, the inclusion of the hindered amine light stabilizing composition with molecular weight ranging from 1000 g/mole to 5000 g/mole (e.g. Chimassorb® 119 or Chimassorb® 944) or the ultraviolet light stabilizing composition (e.g. Tinuvin® 329), the thermoplastic composition exhibited sustained low odor and excellent chemical resistance, while also enhancing the mobility and reducing gloss.

In contrast to embodiment 1, embodiment 10 incorporates a thermoplastic composition augmented with the hindered amine light stabilizing composition with molecular weight ranging from 1000 g/mole to 5000 g/mole (e.g. Chimassorb® 119 or Chimassorb® 944) and the ultraviolet light stabilizing composition (e.g. Tinuvin® 329). This thermoplastic composition exhibits characteristics such as reduced low odor, enhanced chemical resistance, mobility and reduced gloss.

The thermoplastic composition produced in comparative example 1 omitted the use of the paraffin wax and instead incorporated the hindered amine light stabilizing composition with a dipiperidine structure, having molecular weight ranging from 200 g/mole to 600 g/mole; consequently, the result exhibited inferior odor performance, chemical resistance and mobility, and did not allow for further reduction in gloss. In contrast to comparative example 1, the thermoplastic composition in comparative example 2 exhibited slight enhancement in odor performance, chemical resistance, mobility and low gloss. However, it exclusively employed the paraffin wax without incorporating the hindered amine light stabilizing composition with a dipiperidine structure, having molecular weight ranging from 200 g/mole to 600 g/mole. Consequently, it still fail to meet the requirement for application.

In comparative example 3, only the hindered amine light stabilizing composition with the dipiperidine structure and molecular weight ranging from 200 g/mole to 600 g/mole, and the ultraviolet light stabilizing composition, were utilized, while the paraffin wax was not employed. In comparative example 4, the hindered amine light stabilizing composition with the dipiperidine structure and molecular weight ranging from 200 g/mole to 600 g/mole and another hindered amine light stabilizing composition with molecular weight ranging from 1000 g/mole to 5000 g/mole were utilized, while the paraffin wax was omitted. In comparative example 3 and 4, the absence of the paraffin wax in the thermoplastic composition resulted in inferior odor performance, chemical resistance, mobility and low gloss. Compared to comparative example 1, comparative example 5 utilized paraffin wax, and incorporated the hindered amine light stabilizing composition with molecular weight ranging from 1000 g/mole to 5000 g/mole, along with the ultraviolet light stabilizing composition. This result in a slight enhancement in odor performance, chemical resistance, mobility and low gloss. However, the hindered amine light stabilizing composition with a dipiperidine structure and a molecular weight ranging from 200 g/mole to 600 g/mole was not employed. Consequently, the thermoplastic composition still exhibited inferior mobility, low gloss, chemical resistance performance and processability, and thus still failed to meet the requirement for application.

TABLE 2

| | | | | | | | | | | Compar- | Compar- |
|---|---|---|---|---|---|---|---|---|---|---|---|
| | | | Embodi- | Embodi- | Embodi- | Embodi- | Embodi- | Embodi- | Embodi- | ative | ative |
| | | | ment 11 | ment 12 | ment 13 | ment 14 | ment 15 | ment 16 | ment 17 | example 6 | example 7 |
| Compo- | styrene-acrylonitrile | | 65.1 | 65.1 | 65.1 | 65.1 | 60.1 | 70.1 | 70.1 | 65.1 | 65.1 |
| stion | acrylate base rubber | | 34.9 | 34.9 | 34.9 | 34.9 | 39.9 | 29.9 | 29.9 | 34.9 | 34.9 |
| (parts by | grafted copolymers | | | | | | | | | | |
| wight) | paraffin | B-1 | 4 | 4 | | 2 | | 6 | | | 2 |
| | wax (B) | B-2 | | | 4 | 2 | 4 | | 4 | | |
| | hindered amine | C1-1 | 1.0 | 1.0 | 1.0 | 1.0 | 1.0 | 1.5 | 0.6 | 1.0 | |
| | light stabilizer | | | | | | | | | | |
| | with a | | | | | | | | | | |
| | dipiperidine | | | | | | | | | | |
| | structure (C1) | | | | | | | | | | |
| | hindered amine | C2-1 | | 0.5 | | | 0.5 | | 0.6 | | 0.5 |
| | light stabilizer | C2-2 | | 0.5 | 0.7 | | 0.5 | | | | |
| | (C2) | | | | | | | | | | |
| | ultraviolet light | D-2 | 0.5 | 0.5 | 0.5 | 0.5 | 0.5 | 0.7 | 0.3 | 0.5 | 0.5 |
| | stabilizer (D) | | | | | | | | | | |
| | coloring agent, | E-1 | 1.6 | 1.6 | 1.6 | 1.6 | 1.6 | 1.6 | 1.2 | 1.6 | 1.6 |
| | dyes and/or a | | | | | | | | | | |
| | pigment (E) | | | | | | | | | | |
| | other additives | F-1 | 1.04 | 1.04 | 1.04 | 1.04 | 1.04 | 1.04 | 1.04 | 1.04 | 1.04 |
| | (F) | | | | | | | | | | |
| Evalution | MVR (g/10 min) | | 12.1 | 12.5 | 11.8 | 11.0 | 10.5 | 16.2 | 14.1 | 9.8 | 10.5 |
| results | gloss (%) | | 83.0 | 82.6 | 81.9 | 90.2 | 78.2 | 83.1 | 83.5 | 94.0 | 91.1 |
| | chemical | unleaded | E | E | E | E | E | E | E | C | D |
| | resistance | gasoline #95 | | | | | | | | | |
| | | glacial acetic | E | E | E | E | E | E | E | D | D |
| | | acid | | | | | | | | | |

| | | | | | | | | | |
|---|---|---|---|---|---|---|---|---|---|
| odor testing | 1 | 1 | 1 | 1 | 1 | 1 | 1 | 3 | 2 |
| processability | ⊚ | ⊚ | ⊚ | ⊚ | ⊚ | ⊚ | ⊚ | ◯ | ◯ |

In table 2, the composition of B-1, B-2, C1-1, C2-1, C2-2, E-1 and F-1 is identical to that presented in table 1 and is therefore not repeated herein. Additionally, the composition D-2 in table 2 corresponds to the ultraviolet light stabilizing composition produced by BASF SE Company under the product model of Tinuvin® 360.

In embodiments 11-17, the thermoplastic composition exhibited improved properties when the hindered amine light stabilizing composition with molecular weight ranging from 1000 g/mole to 5000 g/mole (e.g. Chimassorb® 119 or Chimassorb® 944) and/or the ultraviolet light stabilizing composition (e.g. Tinuvin® 360) were added, compared to embodiment 1. Additionally, the use of the ultraviolet light stabilizing composition (D-2) in embodiments 11-17 resulted in the same effect as the use of the ultraviolet light stabilizing composition (D-1) in embodiments 8-10, leading to the obtained thermoplastic composition possessing properties such as low odor, excellent chemical resistance, high mobility and low gloss.

In comparative example 6, only the hindered amine light stabilizing composition with a dipiperidine structure and a molecular weight of 200 g/mole to 600 g/mole, as well as the ultraviolet light stabilizing composition, were utilized. However, the paraffin wax was not employed. The results indicated that the absence of paraffin wax resulted in inferior odor performance, chemical resistance, mobility and low gloss. In comparative example 7, the paraffin wax, and the hindered amine light stabilizing composition with molecular weight ranging from 1000 g/mole to 5000 g/mole, as well as the ultraviolet light stabilizing composition were utilized. These resulted in a slight improvement in odor performance, chemical resistance, mobility and low gloss, but the hindered amine light stabilizing composition with a dipiperidine structure and a molecular weight ranging from 200 g/mole to 600 g/mole was omitted. However, despite these improvements, it still could not meet the requirement for application.

According to comparison between embodiments 1-17 and comparative example 1-7, it was observed that the thermoplastic composition solely contained the paraffin wax or the hindered amine light stabilizing composition with a dipiperidine structure and a molecular weight ranging from 200 g/mole to 600 g/mole, the thermoplastic composition exhibit inferior mobility, low gloss, chemical resistance and odor performance. Consequently, it could not meet the requirement for application. Therefore, the incorporation of both the paraffin wax and the hindered amine light stabilizing composition with a dipiperidine structure and a molecular weight ranging from 200 g/mole to 600 g/mole, into the ASA resin in the present invention result in a synergy effect. This effect not only enhances the mobility of the thermoplastic composition, but also enhances the odor performance, chemical resistance, and reduces gloss.

Furthermore, if the thermoplastic composition contained solely the paraffin wax or solely the hindered amine light stabilizing composition with a dipiperidine structure and a molecular weight ranging from 200 g/mole to 600 g/mole, even with addition of either the hindered amine light stabilizing composition with a molecular weight ranging from 1000 g/mole to 5000 g/mole or the ultraviolet light stabilizing composition, mobility, low gloss, chemical resistance and odor performance of the thermoplastic composition still fail to meet the requirement for application.

Obviously, the present invention is evidently on incorporating both paraffin wax and the hindered amine light stabilizing composition with a dipiperidine structure and a molecular weight ranging from 200 g/mole to 600 g/mole into the acrylate-based rubber modified resin composition. This synergistically addition aims to substantially enhance the mobility, low gloss, chemical resistance, and odor performance of the thermoplastic composition, thereby meeting the requirements for application.

In summary, the present invention provides the thermoplastic composition, which includes 100 parts by weight of acrylate-based rubber modified resin composition (A), 0.05 part by weight to 10 parts by weight of paraffin wax (B), and 0.1 part by weight to 2 parts by weight of hindered amine light stabilizing composition with a dipiperidine structure (C1), in which the molecular weight of the hindered amine light stabilizing composition with a dipiperidine structure (C1) is 200 g/mole to 600 g/mole. By the composition with aforementioned amount, the thermoplastic composition of the present invention can exhibit characteristics such as low odor, great chemical resistance, high mobility and low gloss.

Although the present invention has been described in considerable detail with reference to certain embodiments thereof, other embodiments are possible. Therefore, the spirit and scope of the appended claims should not be limited to the description of the embodiments contained herein.

What is claimed is:

1. A thermoplastic composition, comprising:
100 parts by weight of acrylate-based rubber modified resin composition (A), wherein the acrylate-based rubber modified resin composition (A) comprises styrene-acrylonitrile copolymers and acrylate-based rubber grafted copolymers;
0.05 part by weight to 10 parts by weight of paraffin wax (B); and
0.1 part by weight to 2 parts by weight of hindered amine light stabilizing composition with a dipiperidine structure (C1), wherein a molecular weight of the hindered amine light stabilizing composition with a dipiperidine structure (C1) is ranging from 200 g/mole to 600 g/mole.

2. The thermoplastic composition of claim 1, wherein the paraffin wax (B) comprises saturated hydrocarbon with a carbon number of 17 to 50.

3. The thermoplastic composition of claim 1, wherein a melting point of the paraffin wax (B) is below 75° C.

4. The thermoplastic composition of claim 1, wherein a melting point of the paraffin wax (B) is above 40° C., but below 75° C.

5. The thermoplastic composition of claim 1, wherein a weight ratio between the paraffin wax (B) and the hindered amine light stabilizing composition with a dipiperidine structure (C1) is 0.025 to 100.

6. The thermoplastic composition of claim 1, wherein the hindered amine light stabilizing composition with a dipiperidine structure (C1) has a structure of following formula (I).

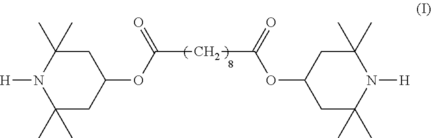

7. The thermoplastic composition of claim 1, further comprising:
0.1 part by weight to 1.6 parts by weight of hindered amine light stabilizing composition (C2), wherein a molecular weight of the hindered amine light stabilizing composition (C2) is ranging from 1000 g/mole to 5000 g/mole.

8. The thermoplastic composition of claim 7, wherein the hindered amine light stabilizing composition (C2) comprises a structure of formula (II) and/or formula (III): 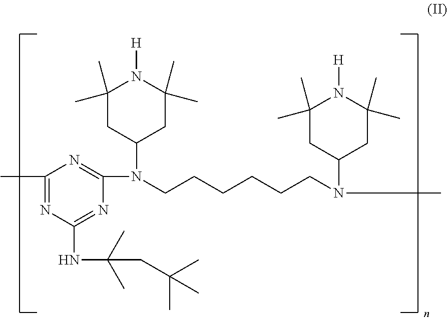 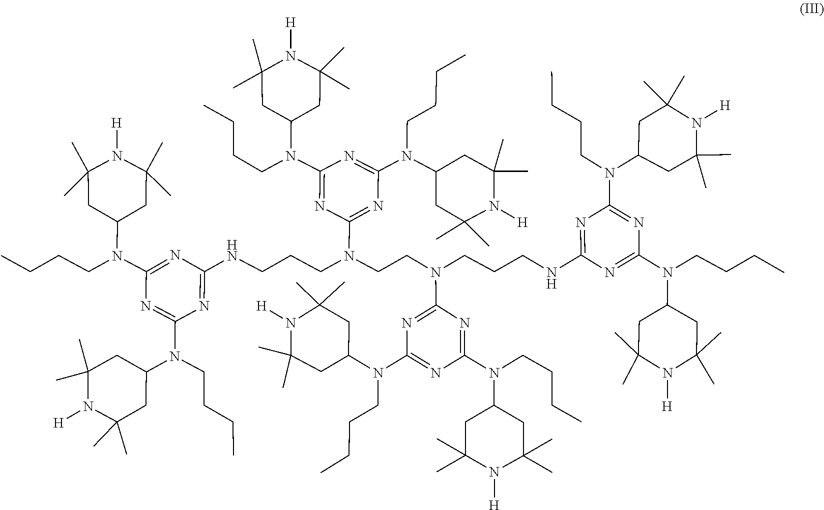
in the formula (II), n represents an integer between 2 and 20.

9. The thermoplastic composition of claim 8, wherein an amount of the hindered amine light stabilizing composition (C2) having the structure of the formula (III) is 0.1 part by weight to 1.0 part by weight.

10. The thermoplastic composition of claim 7, wherein a weight ratio between the hindered amine light stabilizing composition with a dipiperidine structure (C1) and the hindered amine light stabilizing composition (C2) is 0.06 to 20.

11. The thermoplastic composition of claim 1, further comprising:
0.1 part by weight to 1.5 parts by weight of an ultraviolet light stabilizing composition (D).

12. The thermoplastic composition of claim 11, wherein the ultraviolet light stabilizing composition (D) is selected from the group consisting of benzotriazole-based ultraviolet light stabilizing composition.

13. The thermoplastic composition of claim 11, wherein the ultraviolet light stabilizing composition (D) is selected from the group consisting of 2-(2′-hydroxy-5′-tert-octylphenyl)benzotriazole and 2,2′-methylenebis[6-(benzotriazol-2-yl)-4-tert-octylphenol].

14. The thermoplastic composition of claim 11, wherein a weight ratio between the hindered amine light stabilizing composition with a dipiperidine structure (C1) and the ultraviolet light stabilizing composition (D) is 0.06 to 20.

15. The thermoplastic composition of claim 1, further comprising:
0.1 part by weight to 10 parts by weight of a coloring agent, a dye and/or a pigment (E).

16. The thermoplastic composition of claim 1, further comprising:
0.05 part by weight to 5 parts by weight of other additives (F).

17. A molding product, comprising the thermoplastic composition of claim 1.

18. A method for producing a thermoplastic composition, comprising:
providing a composition, wherein the composition comprises:
100 parts by weight of acrylate-based rubber modified resin composition (A), wherein the acrylate-based rubber modified resin composition (A) comprises styrene-acrylonitrile copolymers and acrylate-based rubber grafted copolymers;
0.05 part by weight to 10 parts by weight of paraffin wax (B); and
0.1 part by weight to 2 parts by weight of hindered amine light stabilizing composition with a dipiperidine structure (C1), wherein a molecular weight of the hindered amine light stabilizing composition with a dipiperidine structure (C1) is ranging from 200 g/mole to 600 g/mole; and
performing a compounding operation to the composition to obtain the thermoplastic composition.

19. The method for producing the thermoplastic composition of claim 18, wherein the paraffin wax (B) comprises saturated hydrocarbon with a carbon number of 17 to 50.
